(19) United States
(12) Patent Application Publication
(10) Pub. No.: US 2025/0230009 A1
(43) Pub. Date: Jul. 17, 2025

(54) HEAT TREATMENT APPARATUS AND GUIDE ROLLER FOR HEAT TREATMENT APPARATUS

(71) Applicant: Noritake Co., Limited, Nagoya-shi (JP)

(72) Inventors: Hidenori Nakamura, Nagoya-shi (JP); Hideaki Ohi, Nagoya-shi (JP); Masaki Iida, Nagoya-shi (JP)

(73) Assignee: Noritake Co., Limited, Nagoya-shi (JP)

(21) Appl. No.: 19/016,979

(22) Filed: Jan. 10, 2025

(30) Foreign Application Priority Data
Jan. 11, 2024 (JP) 2024-002835

(51) Int. Cl. B65H 20/02; B65H 37/00

(52) U.S. Cl. CPC B65H 20/02; B65H 37/00; B65H 2404/17

(57) ABSTRACT

A heat treatment apparatus includes a conveyance device, an outer wall, and guide rollers. The conveyance device conveys a workpiece. The outer wall has a processing space therein where the workpiece is processed while being conveyed. The guide roller is provided in the processing space and guides the workpiece. The guide roller includes a shaft, a first bearing and a second bearing, a cylindrical roller body, and a first cover and a second cover. The first cover and the second cover close corresponding gaps between an inner ring and an outer ring, on the outer sides of the first bearing and the second bearing, respectively, along the axial direction of the shaft.

### CROSS REFERENCE TO RELATED APPLICATION(S)

This application claims the benefit of priority of Japanese Patent Application No. 2024-002835 filed on Jan. 11, 2024, the entire contents of which are hereby incorporated herein by reference.

### BACKGROUND OF THE DISCLOSURE

The present disclosure relates to a heat treatment apparatus and a guide roller for the heat treatment apparatus.

Japanese Patent Publication No. 7285360 discloses a heat treatment apparatus that includes an unwinding unit, a heat treatment unit, a cooling unit, and a winding unit. From the unwinding unit, a strip-shaped sheet is unwound before heat treatment. In the heat treatment unit, the sheet is heat-treated while being conveyed. In the cooling unit, the sheet heat-treated in the heat treatment unit is cooled while being conveyed. In the winding unit, the strip-shaped sheet cooled in the cooling unit is wound. Throughout the unwinding unit, heat treatment unit, cooling unit, and winding unit, the sheet being conveyed is guided by guide rollers.

### SUMMARY

The present inventors intend to improve the cleanliness of a processing space where a workpiece is processed.

A heat treatment apparatus disclosed herein includes a conveyance device, an outer wall, and a guide roller. The conveyance device conveys a workpiece. The outer wall has therein a processing space where the workpiece is processed while being conveyed. The guide roller is provided in the processing space and guides the workpiece. The guide roller includes a shaft, a first bearing and a second bearing, a cylindrical roller body, and a first cover and a second cover. The first bearing and the second bearing are attached with a spacing therebetween in an axial direction of the shaft. The roller body is rotatably attached to the shaft via the first bearing and the second bearing. Each of the first bearing and the second bearing includes an inner ring, an outer ring, a rolling element, and a retainer. The first cover and the second cover close corresponding gaps between the inner ring and the outer ring, on outer sides of the first bearing and the second bearing, respectively, along the axial direction of the shaft. This heat treatment apparatus improves the cleanliness of the processing space where the workpiece is processed.

### BRIEF DESCRIPTION OF THE DRAWINGS

FIG. 1 is a schematic diagram illustrating a heat treatment apparatus 10.

FIG. 2 is a schematic diagram illustrating a drive mechanism for a workpiece A.

FIG. 3 is a schematic diagram of a guide roller 45.

FIG. 4 is a schematic diagram of a second support member 44b.

### DETAILED DESCRIPTION OF THE PREFERRED EMBODIMENTS

One embodiment in the present disclosure will be described in detail below with reference to the drawings. In the following drawings, members and portions that have the same actions are denoted by the same symbols. The dimensional relationships (length, width, thickness, etc.) in each drawing do not reflect the actual dimensional relationships. The directions of up, down, left, right, front, and back are represented are represented by arrows U, D, L, R, F, and Rr, respectively, in the figures. Here, the directions of up, down, left, right, front, and back are only provided for convenience of explanation and do not limit the present disclosure unless otherwise specifically mentioned.

### <Heat Treatment Apparatus 10>

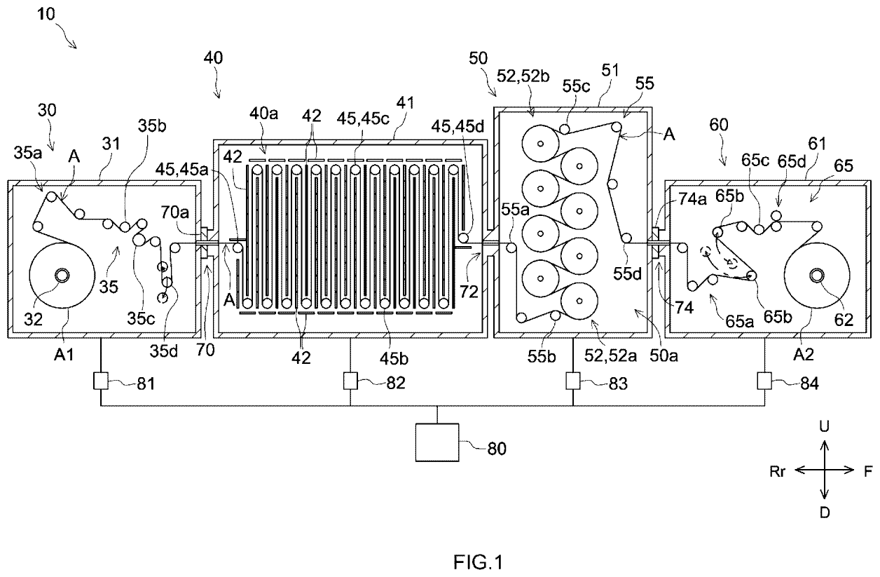

FIG. 1 is a schematic diagram illustrating a heat treatment apparatus 10. The heat treatment apparatus 10 is equipment for performing heat treatment on a strip-shaped (sheet-shaped) workpiece A, which is an object to be processed. In this embodiment, the heat treatment apparatus 10 is a device for continuously drying a strip-shaped workpiece while conveying it in a so-called roll-to-roll system. The workpiece A is not particularly limited as long as it is a strip-shaped object, such as an electrode sheet for secondary batteries that has an electrode material applied to both sides of a sheet base, a Flexible Copper Clad Laminate (FCCL), or a polyimide sheet. The heat treatment apparatus 10 can be used to perform the treatment on a variety of strip-shaped (sheet-shaped) workpieces.

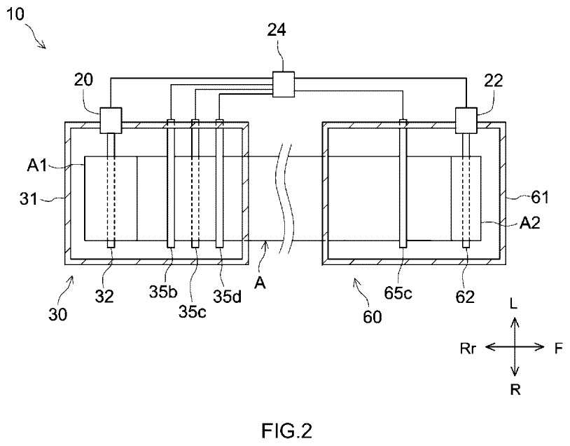

The heat treatment apparatus 10 includes conveyance devices 20 and 22 (see FIG. 2), an outer wall 41 (see FIG. 1), and guide rollers 45 (see FIG. 1).

As illustrated in FIG. 1, the heat treatment apparatus 10 includes an unwinding unit 30, a heat treatment unit 40, a cooling unit 50, and a winding unit 60.

The strip-shaped workpiece A is processed while being conveyed, through the unwinding unit 30, the heat treatment unit 40, the cooling unit 50, and the winding unit 60 in that order. The workpiece A is unwound from an unwinding roll A1 provided in the unwinding unit 30, heat-treated in the heat treatment unit 40, cooled in the cooling unit 50, and then wound onto a winding roll A2 provided in the winding unit 60.

### <Conveyance Devices 20 and 22>

FIG. 2 is a schematic diagram illustrating a drive mechanism for the workpiece A. In FIG. 2, the illustration of the heat treatment unit 40 and the cooling unit 50, which are arranged between the unwinding unit 30 and the winding unit 60, is omitted. The conveyance devices 20 and 22 are devices that convey the workpiece A. The workpiece A is conveyed along a predetermined conveyance route. As illustrated in FIG. 2, the conveyance devices 20 and 22 are devices that rotationally drive an unwinding shaft 32, on which the unwinding roll A1 of the unwinding unit 30 is attached, as well as a winding shaft 62, on which the winding roll A2 of the winding unit 60 is attached, respectively. In this embodiment, motors are used as the conveyance devices 20 and 22. Each of the conveyance devices 20 and 22 can be constituted of a device that controls the conveyance of the workpiece A. For example, a motor and an inverter may be used as the conveyance devices 20 and 22, and particularly a servo motor or the like may be used.

The conveyance devices 20 and 22 may include a device that controls a tension applied to the workpiece A. For example, a powder clutch may be used as the device for controlling the tension. The conveyance devices 20 and 22 may be implemented by a system in which a device for controlling the conveyance speed and a device for controlling the tension cooperate with each other.

The conveyance devices 20 and 22 are attached to an outer wall 31 of the unwinding unit 30 and an outer wall 61 of the winding unit 60, respectively. The unwinding shaft 32 is connected to the conveyance device 20. The unwinding shaft 32 is rotationally driven by the conveyance device 20, thereby unwinding the workpiece A from the unwinding roll A1. The winding shaft 62 is connected to the conveyance device 22. The winding shaft 62 is rotationally driven by the conveyance device 22, thereby winding the workpiece A onto the winding roll A2. The conveyance devices 20 and 22 may be installed in an atmospheric box provided in a space enclosed by the outer walls 31 and 61, respectively.

The heat treatment apparatus 10 can be configured to convey the workpiece A at a high speed in order to improve the processing efficiency of the workpiece A. Although not particularly limited, the conveyance speed of the workpiece A can be set to about 1 m/min to 200 m/min. In this embodiment, the conveyance speed of the workpiece A is set to about 100 m/min.

In the heat treatment apparatus 10, the conveyance speed of the workpiece A is controlled by a controller 24.

### <Controller 24>

The controller 24 controls the conveyance speed of the workpiece A, the tension applied to the workpiece A, and the like such that the workpiece A is conveyed according to a predetermined conveyance condition. In this embodiment, the controller 24 respectively controls an unwinding tension applied when the workpiece A is unwound, an in-furnace tension applied to the workpiece A being processed, and a winding tension applied when the heat-treated workpiece A is wound up. The controller 24 is connected to the conveyance devices 20 and 22. The controller 24 is also connected to a tension detection roller 35b, a feed roller 35c, a dancer roller 35d, a tension detection roller 65c, and the like. The controller 24 feeds back the unwinding tension detected by the tension detection roller 35b to the conveyance device 20 and thereby controls the torque of the unwinding shaft 32. Thus, the unwinding tension is adjusted. The controller 24 also feeds back the in-furnace tension detected by the tension detection roller 35b, on which the workpiece A being processed is hung, to the dancer roller 35d. The dancer roller 35d moves according to the detected in-furnace tension. Thus, the in-furnace tension is adjusted. The rotation speed of the feed roller 35c is controlled such that the position of the dancer roller 35d returns to a reference position with the in-furnace tension being constant. The controller 24 feeds back the winding tension detected by the tension detection roller 65c to the conveyance device 22 and thereby controls the torque of the winding shaft 62. Thus, the winding tension is adjusted.

### <Unwinding Unit 30>

As illustrated in FIG. 1, the unwinding unit 30 houses the unwinding roll A1 with the workpiece A wound thereon before the heat treatment.

The unwinding unit 30 has the outer wall 31 that encloses internal equipment and the unwinding roll A1. The unwinding unit 30 includes therein the unwinding shaft 32 and plural rollers 35. The unwinding shaft 32 is a shaft to which the unwinding roll A1, holding the workpiece A wound on it before heat treatment, is attached. In this embodiment, the unwinding shaft 32 is rotationally driven to unwind the workpiece A from the unwinding roll A1 attached to the unwinding shaft 32.

Within the space enclosed by the outer wall 31 of the unwinding unit 30, the plural rollers 35 that set the conveyance route for the workpiece A are provided. The workpiece A unwound from the unwinding roll A1 is hung around and sequentially passed through the plural rollers 35 in a predetermined order and then conveyed toward the heat treatment unit 40.

The plural rollers 35 include guide rollers 35a, the tension detection roller 35b, the feed roller 35c, and the dancer roller 35d. The tension detection roller 35b is a roller for detecting the tension applied to the workpiece A. A tension detector (not illustrated) is attached to the tension detection roller 35b. The dancer roller 35d is configured to be movable within a predetermined range. By moving the dancer roller 35d, the tension applied to the workpiece A is adjusted. The feed roller 35c is rotationally driven by a drive device (not illustrated). By controlling the rotation of the feed roller 35c, the position of the dancer roller 35d is adjusted.

### <Heat Treatment Unit 40>

The heat treatment unit 40 is equipment where the strip-shaped workpiece A is heat-treated while being conveyed. The heat treatment unit 40 is connected to the unwinding unit 30 via a connecting part 70. The connecting part 70 is provided with an outlet for the unwinding unit 30 and an inlet for the heat treatment unit 40. A path through which the workpiece A passes is formed in the connecting part 70. The workpiece A is conveyed from the unwinding unit 30 to the heat treatment unit 40 through the connecting part 70. The path for the workpiece A formed in the connecting part 70 is set to have dimensions slightly larger than the width and thickness of the workpiece A. This reduces the likelihood of interference between the atmosphere of the heat treatment unit 40 and that of the unwinding unit 30.

The heat treatment unit 40 includes the outer wall 41 (furnace body 41), heaters 42, and the guide rollers 45 (45a to 45d). The outer wall 41 has therein a processing space 40a where the workpiece A is processed while being conveyed. The outer wall 41 encloses the processing space 40a in which the heater 42 and the guide rollers 45 are arranged.

### <Guide Rollers 45>

The guide rollers 45 are provided within the processing space 40a. The guide roller 45 is a roller that guides the workpiece A. The conveyance route along which the workpiece A is conveyed is set by the guide rollers 45. The guide roller 45 is configured to rotate in a driven manner as the workpiece A is conveyed. In this embodiment, each guide roller 45 is a substantially cylindrical roller. A guide roller 45a is provided near the inlet (connecting part 70) of the heat treatment unit 40. Plural guide rollers 45b are arranged at a predetermined pitch from the inlet to an outlet in a lower portion of the heat treatment unit 40. Plural guide rollers 45c are arranged in an upper portion of the heat treatment unit 40 while being offset by half a pitch from the plural guide rollers 45b. A guide roller 45d is provided near the outlet (connecting part 72) of the heat treatment unit 40.

The workpiece A is hung on the guide roller 45a near the inlet of the heat treatment unit 40 and conveyed downward. Thereafter, the workpiece A is alternately hung around the upper and lower guide rollers 45b and 45c in sequence from the inlet toward the outlet. Thus, in the heat treatment unit 40, the workpiece A moves vertically up and down as it progresses from the inlet to the outlet.

### <Heater 42>

The heater 42 is equipment for heating the workpiece A. In this embodiment, the heaters 42 are arranged around the workpiece A which progresses from the inlet to the outlet, in a way that appears to fold up and down. The heater 42 is also arranged in each gap between portions of the workpiece A, which is folded up and down while being hung over the guide rollers 45b and 45c. Each heater 42 is arranged to face the workpiece A. The heater 42 may be fixed, for example, by a heater holder or a support.

In this embodiment, a far-infrared heating type plate heater is used as the heater 42. Various types of heaters may be used as the heater 42, depending on the heating temperature, heating atmosphere, and the like. For example, a cylindrical heater may be used as the heater 42, in addition to the plate heater. The material of the heater 42 is not particularly limited, and a metal sheath heater, a ceramic heater, a lamp heater, or the like may be used. The heater 42 is not limited to the far-infrared heating type heater. In the case of an atmospheric furnace, for example, a hot-air heating type heater that blows hot air onto a workpiece or an infrared heating type lamp heater may be used as the heater 42. The heat-treated workpiece A is conveyed out toward the cooling unit 50 through the guide roller 45d provided near the outlet.

### <Cooling Unit 50>

The cooling unit 50 is equipment in which the workpiece A heat-treated in the heat treatment unit 40 is cooled while being conveyed. The cooling unit 50 is connected to the heat treatment unit 40 via the connecting part 72. The connecting part 72 is provided with the outlet for the heat treatment unit 40 and an inlet for the cooling unit 50.

Similar to the connecting part 70, a path through which the workpiece A passes is formed in the connecting part 72. The configuration of the connecting part 72 can be made in the same manner as that of the connecting part 70, and thus a detailed description thereof is omitted.

The cooling unit 50 includes cooling rollers 52, guide rollers 55, and an outer wall 51. The outer wall 51 encloses a processing space 50a in which the plural cooling rollers 52 and the plural guide rollers 55 are arranged. In this embodiment, the plural cooling rollers 52 are provided in the cooling unit 50. The plural cooling rollers 52 and the plural guide rollers 55 set a conveyance route along which the workpiece A is conveyed within the cooling unit 50. The number of cooling rollers 52 may be singular, but plural cooling rollers 52 are preferred.

### <Cooling Roller 52>

The cooling roller 52 is a roller configured to allow the circulation of the refrigerant. The workpiece A is cooled by contacting a surface of the cooling roller 52. The cooling rollers 52 include first cooling rollers 52a and second cooling rollers 52b. The first cooling roller 52a is the cooling roller 52 around which the workpiece A is hung with one surface of the workpiece A being in contact with the roller. The second cooling roller 52b is the cooling roller 52 around which the workpiece A is hung with the other surface of the workpiece A being in contact with the roller. In this embodiment, the cooling rollers 52 are connected to a drive device (not illustrated). The cooling roller 52 rotates along the conveyance direction at a set conveyance speed. In this embodiment, the workpiece A is cooled to about room temperature in the cooling unit 50. The temperature to which the workpiece A is cooled is not particularly limited.

The number of first cooling rollers 52a is plural (four in this embodiment). The same applies to the second cooling roller 52b. The number of cooling rollers 52 is not particularly limited. However, one first cooling roller 52a and one second cooling roller 52b may be provided.

The plural first cooling rollers 52a are arranged in a row at a predetermined pitch along the height direction at the front (outlet side) of the cooling unit 50. The plural second cooling rollers 52b are arranged in a row at a predetermined pitch along the height direction at the rear (inlet side) of the cooling unit 50. A spacing between adjacent first cooling rollers 52a and a spacing between adjacent second cooling rollers 52b are both set to be narrower than an outer diameter of the cooling roller 52. Note that the arrangement of the first cooling rollers 52a and the second cooling rollers 52b is not particularly limited.

Here, the first cooling rollers 52a and the second cooling rollers 52b are arranged at the same pitch. The second cooling roller 52b is positioned by half a pitch higher than the first cooling roller 52a, as viewed from the bottom. Thus, the plural first cooling rollers 52a and the plural second cooling rollers 52b are arranged such that their heights differ sequentially at the front and rear of the cooling unit 50, respectively. In other words, the plural first cooling rollers 52a and the plural second cooling rollers 52b are arranged in a staggered manner. This allows the cooling unit 50 to be elongated in the height direction. On the other hand, an occupied area of the cooling unit 50 can be reduced to save a space in the equipment.

### <Guide Rollers 55>

The guide rollers 55 (55a to 55d) are rollers that guide the workpiece A. In this embodiment, each guide roller 55 is a substantially cylindrical roller. In the cooling unit 50, the conveyance route for the workpiece A is set by the plural guide rollers 55 such that it is directed from the inlet (connecting part 72) toward the outlet (connecting part 74) through the plural cooling rollers 52. The plural guide rollers 55 may include a tension detection roller that detects the tension applied to the workpiece A.

The workpiece A is introduced into the cooling unit 50 from the inlet of the cooling unit 50 through the guide roller 55a. The workpiece A is conveyed downward. The workpiece A is conveyed to the first cooling roller 52a, which is arranged at the lowermost end, through the guide roller 55b. The workpiece A is then alternately hung around the first cooling rollers 52a and the second cooling rollers 52b in sequence as viewed from the bottom, and is conveyed from the second cooling roller 52b, which is arranged at the uppermost end, toward the guide roller 55c. The workpiece A is then conveyed downward through the guide roller 55c and is conveyed from an outlet of the cooling unit 50 to the winding unit 60 through the guide rollers 55d. Here, the workpiece A is hung around the first cooling roller 52a and the second cooling roller 52b such that respective different sides of the workpiece A come into contact with the first and second cooling rollers in sequence.

The cooling unit 50 is connected to the winding unit 60 via the connecting part 74. The connecting part 74 includes the outlet of the cooling unit 50 and an inlet of the winding unit 60. The cooled workpiece A is conveyed to the winding unit 60 through the connecting part 74.

### <Winding Unit 60>

The winding unit 60 is equipment that winds up the workpiece A. The winding unit 60 houses the winding roll A2 for winding up the workpiece A that has been cooled through the cooling rollers 52.

The winding unit 60 includes the outer wall 61 surrounding internal equipment and the winding roll A2. The winding unit 60 includes the winding shaft 62 and plural rollers 65. The winding roll A2 is attached to the winding shaft 62, and the workpiece A, which has been heat-treated in the heat treatment unit 40 and cooled in the cooling unit 50, is wound onto the winding roll A2. By rotationally driving the winding shaft 62, the workpiece A is wound onto the winding roll A2.

Within the space enclosed by the outer wall 61 of the winding unit 60, the plural rollers 65 that set the conveyance route for the workpiece A are provided. The plural rollers 65 set the conveyance route along which the workpiece A is conveyed within the winding unit 60. The workpiece A conveyed from the cooling unit 50 is hung over the roller 65 near the inlet (connecting part 74) of the winding unit 60, then hung around the plural rollers 65 in the predetermined order, and eventually wound onto the winding roll A2. The plural rollers 65 include guide rollers 65a, a dancer roller 65b, the tension detection roller 65c, and feed rollers 65d. The dancer roller 65b is configured to be movable within a predetermined range. The dancer roller 65b can be moved, for example, to secure a necessary extra length of the workpiece A when the winding roll A2 is replaced. A tension detector (not illustrated) is attached to the tension detection roller 65c. The feed roller 65d feeds out the necessary extra length of the workpiece A when the workpiece A is attached to a new winding roll A2 after the replacement of the winding roll A2.

### <Vacuum Pump 80>

The heat treatment apparatus 10 includes a vacuum pump 80. Interior spaces of the unwinding unit 30, the heat treatment unit 40, the cooling unit 50, and the winding unit 60 described above are enclosed by the outer walls 31, 41, 51, and 61, respectively. The unwinding unit 30, the heat treatment unit 40, the cooling unit 50, and the winding unit 60 have spaces isolated from an external space by the outer walls 31, 41, 51, and 61, respectively. The spaces inside the outer walls 31, 41, 51, and 61 communicate with each other when the workpiece A is processed. The vacuum pump 80 is connected to the outer walls 31, 41, 51, and 61 of the respective units.

The vacuum pump 80 reduces the pressure in the interior spaces of the unwinding unit 30, the heat treatment unit 40, the cooling unit 50, and the winding unit 60 (the processing spaces 40a and 50a in the heat treatment unit 40 and the cooling unit 50, respectively). In this embodiment, the workpiece A is processed under a predetermined vacuum atmosphere with a pressure lower than atmospheric pressure.

The connection form of the vacuum pump 80 is not particularly limited. Plural vacuum pumps 80 may be provided, and the respective vacuum pumps 80 may be connected to the unwinding unit 30, the heat treatment unit 40, the cooling unit 50, and the winding unit 60. Alternatively, pipes may be branched from one vacuum pump 80 to reduce the pressure inside some of the unwinding unit 30, the heat treatment unit 40, the cooling unit 50, and the winding unit 60.

The pipe of the vacuum pump 80 is provided with vacuum valves 81 to 84 for adjusting the vacuum level in each unit.

The vacuum valves 81 to 84 are configured to be switchable between the connection of each unit to the vacuum pump 80 and the disconnection of each unit from the vacuum pump 80. In a case where the vacuum level of each unit is not adjusted, open/close valves may be used instead of the vacuum valves 81 to 84.

A door 70a is provided at the inlet of the heat treatment unit 40 (in this embodiment, the connecting part 70). The door 70a is closed when replacing the unwinding roll A1 or the like. By closing the door 70a when replacing the unwinding roll A1 or the like, the atmosphere of the heat treatment unit 40 (in this embodiment, a reduced pressure state) can be maintained. The door 70a may be closed when the workpiece A passes through the connecting part 70, such as when the unwinding roll A1 is replaced. When the remaining workpiece A on the unwinding roll A1 is nearly depleted, the unwinding roll A1 is replaced with a new one. The end of a workpiece A on the newly installed unwinding roll A1 after the replacement and the end of the workpiece A from the previous roll before the replacement are joined together. With the workpiece A remaining in the processing space 40a, the unwinding roll A1 can be replaced while maintaining the atmosphere in the heat treatment unit 40, allowing for a quick recovery of the apparatus after the replacement of the unwinding roll A1.

A door 74a is provided at the outlet of the cooling unit 50 (in this embodiment, the connecting part 74). Like the door 70a, the door 74a can maintain the atmosphere (in this embodiment, the reduced pressure state) in the cooling unit 50 by closing the door 74a when replacing the winding roll A2 or the like. The door 74a may be closed when the workpiece A passes through the connecting part 74, such as when the winding roll A2 is replaced. When the amount of workpiece A wound on the winding roll A2 becomes significant, the winding roll A2 is replaced with a new one. A leading edge of the newly installed winding roll A2 after the replacement and the end of the workpiece Aare joined together. With the workpiece A remaining in the processing space, the winding roll A2 can be replaced while maintaining the atmosphere in the cooling unit 50, allowing for a quick recovery of the apparatus after the replacement of the winding roll A2.

The heat treatment apparatus in which a strip-shaped workpiece is processed while being conveyed includes the conveyance device, the outer wall having therein the processing space, and the guide rollers. The strip-shaped workpiece is conveyed along the predetermined conveyance route within the processing space. In other words, the conveyance route for the strip-shaped workpiece is set by the guide rollers. The strip-shaped workpiece is conveyed while being hung on the guide rollers. The guide rollers are so-called free rollers, and are configured to rotate following the conveyance of the strip-shaped workpiece. Hereinafter, the heat treatment apparatus disclosed herein will be described by using the configuration of the heat treatment unit as an example.

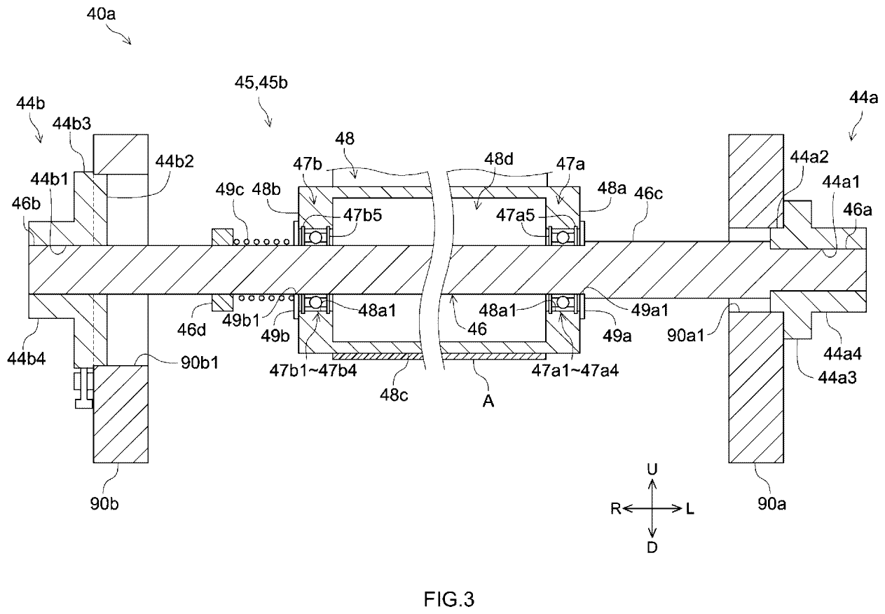

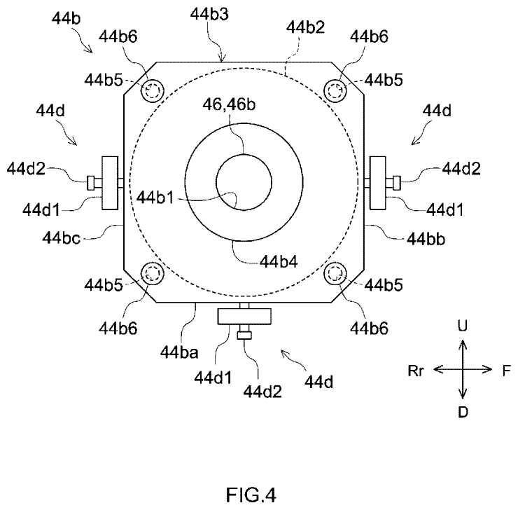

The heat treatment unit 40 of the heat treatment apparatus 10 disclosed herein is provided with the guide rollers 45 that guide the strip-shaped workpiece A. FIG. 3 is a schematic diagram of the guide roller 45. In FIG. 3, the cross-section of the guide roller 45 taken along its axial direction is schematically illustrated. FIG. 3 illustrates the cross-section of the guide roller 45b (hereinafter also referred to simply as the “guide roller 45”) arranged in the lower portion of the heat treatment unit 40, viewed from the front. FIG. 4 is a schematic diagram of a second support member 44b. In FIG. 4, the plane of the second support member 44b viewed from the outside of a shaft 46 in the axial direction is schematically illustrated.

### <Guide Rollers 45>

As illustrated in FIG. 3, the guide roller 45 includes the shaft 46, a first bearing 47a and a second bearing 47b, a cylindrical roller body 48, and a first cover 49a and a second cover 49b. The guide rollers 45 are provided within the processing space 40a enclosed by the outer wall 41 as described above.

### <Shaft 46>

The shaft 46 is a member that serves as the center of the rotation axis of the guide roller 45. The shaft 46 has a substantially cylindrical shape. The material of the shaft 46 is not particularly limited as long as it can withstand the tension applied during the conveyance of the workpiece A (see FIG. 1) and the temperature inside the heat treatment unit 40 (see FIG. 1). In this embodiment, the shaft 46 is made of stainless steel.

The shaft 46 has a first end portion 46a and a second end portion 46b. The first end portion 46a is a right-side end portion of the shaft 46. The second end portion 46b is an end portion opposite to the first end portion 46a. The second end portion 46b is the left-side end portion of the shaft 46.

The first end portion 46a and the second end portion 46b of the shaft 46 are fixed within the processing space 40a by a first support member 44a, a second support member 44b and a pair of support plates 90a and 90b, described below. The first bearing 47a and the second bearing 47b are attached to the shaft 46, between the first end portion 46a and the second end portion 46b.

<First Bearing 47a and Second Bearing 47b>

The first bearing 47a and the second bearing 47b are attached with a spacing therebetween in the axial direction of the shaft 46. In this embodiment, the first bearing 47a and the second bearing 47b have inner ring 47al and 47b1, outer ring 47a2 and 47b2, plural rolling elements 47a3 and 47b3, and retainers 47a4 and 47b4, respectively. The first bearing 47a and the second bearing 47b are so-called rolling bearings.

The inner rings 47a1 and 47b1 are components that are affixed to the shaft 46. The outer rings 47a2 and 47b2 are opposed to the inner rings 47al and 47b1 in the radial direction, respectively. The outer rings 47a2 and 47b2 are components that are affixed to the roller body 48. The plural rolling elements 47a3 are components that are arranged between the inner ring 47al and the outer ring 47a2. The plural rolling elements 47b3 are components that are arranged between the inner ring 47b1 and the outer ring 47b2. The plural rolling elements 47a3 roll between an outer circumferential surface of the inner ring 47al and an inner circumferential surface of the outer ring 47a2. The plural rolling elements 47b3 roll between an outer circumferential surface of the inner ring 47b1 and an inner circumferential surface of the outer ring 47b2. Balls or rollers are used as the rolling elements 47a3 and 47b3. A cylindrical roller, a needle roller, a tapered roller, or the like can be used as the roller. The retainer 47a4 is a component that is arranged between the inner ring 47al and the outer ring 47a2. The retainer 47b4 is a component that is arranged between the inner ring 47b1 and the outer ring 47b2. The retainer 47a4 is a component that retains the plural rolling elements 47a3 between the inner ring 47al and the outer ring 47a2. The retainer 47b4 is a component that retains the plural rolling elements 47b3 between the inner ring 47b1 and the outer ring 47b2.

In this embodiment, the inner rings 47al and 47b1, the outer rings 47a2 and 47b2, the plural rolling elements 47a3 and 47b3 and the retainers 47a4 and 47b4 are made of ceramic. The first bearing 47a and the second bearing 47b are ceramic bearings. The inner rings 47al and 47b1, the outer rings 47a2 and 47b2, the plural rolling elements 47a3 and 47b3 and the retainers 47a4 and 47b4 can be made of, for example, an oxide-based ceramic, a fluoride-based ceramic, or the like. By using ceramic bearings as the first bearing 47a and the second bearing 47b, heat resistance of the bearings can be improved. Thus, the durability of the first bearing 47a and the second bearing 47b can remain satisfactory even when used in the heat treatment unit 40. However, the first bearing 47a and the second bearing 47b are not limited to ceramic bearings.

The first bearing 47a is attached to a first end portion 48a of the roller body 48 and the shaft 46 by a pair of rings 47a5 attached to the inside and outside of the first bearing 47a. The second bearing 47b is attached to a second end portion 48b of the roller body 48 and the shaft 46 by a pair of rings 47b5 attached to the inside and outside of the second bearing 47b.

### <Roller Body 48>

The roller body 48 is a cylindrical member. The roller body 48 is rotatably attached to the shaft 46 via the first bearing 47a and the second bearing 47b. The workpiece A is conveyed along an outer circumferential surface 48c of the roller body 48. The roller body 48 has the first end portion 48a and the second end portion 48b. The first end portion 48a is the right-side end portion of the roller body 48. The second end portion 48b is the left-side end portion of the roller body 48. The first end portion 48a and the second end portion 48b have openings 48al and 48b1 formed therein, respectively.

Each of the first end portion 48a and the second end portion 48b extends from the substantially cylindrical roller body 48 in the inner radial direction. Because of this, the inner diameter of each of the first end portion 48a and the second end portion 48b is smaller than the inner diameter of a portion of the roller body between the first and second end portions 48a and 48b. A space 48d is formed between the roller body 48 and the shaft 46. This can reduce friction applied to the first bearing 47a and the second bearing 47b. In addition, the guide roller 45 is reduced in weight.

The first bearing 47a and the second bearing 47b are attached to the openings 48al and 48b1 of the first end portion 48a and the second end portion 48b of the roller body 48, respectively. As a result, the roller body 48 can be rotatably supported in the circumferential direction with respect to the shaft 46 fixed within the processing space 40a. Thus, the guide roller 45 rotates following the conveyance of the workpiece A when the workpiece A is conveyed. The first cover 49a and the second cover 49b are provided on the outer sides of the first end portion 48a and the second end portion 48b of the roller body 48, respectively. In this embodiment, the roller body 48 is made of stainless steel. However, the material of the roller body 48 is not particularly limited.

<First Cover 49a and Second Cover 49b>

The first cover 49a closes a gap between the inner ring 47al and the outer ring 47a2, on the outer side of the first bearing 47a along the axial direction of the shaft 46. The second cover 49b closes a gap between the inner ring 47b1 and the outer ring 47b2, on the outer side of the second bearing 47b along the axial direction of the shaft 46. In this embodiment, the first cover 49a and the second cover 49b are plate-shaped members.

In this embodiment, the first cover 49a and the second cover 49b are substantially disk-shaped. The first cover 49a and the second cover 49b have outer diameters larger than inner diameters of the openings 48al and 48b1 of the first end portion 48a and the second end portion 48b of the roller body 48, respectively. The first cover 49a and the second cover 49b are provided with insertion holes 49al and 49b1, respectively, through which the shaft 46 is inserted. Each of the inner diameters of the insertion holes 49al and 49b1 is substantially the same as the outer diameter of the shaft 46. In this embodiment, the first cover 49a and the second cover 49b are made of stainless steel. However, the material of the first cover 49a and the second cover 49b is not limited to stainless steel.

In this embodiment, the shaft 46 is provided with a stepped portion 46c. The stepped portion 46c is provided outside the position where the first bearing 47a is attached. A gap is formed between the first end portion 48a of the roller body 48 and the stepped portion 46c. The first cover 49a has a thickness that is substantially the same as the gap. Consequently, the first cover 49a is sandwiched between the stepped portion 46c and the first end portion 48a of the roller body 48. The first cover 49a closes the first end portion 48a of the roller body 48 while being positioned by the stepped portion 46c and the first end portion 48a of the roller body 48.

In this embodiment, the shaft 46 is provided with a spring seat 46d. The spring seat 46d is provided outside the second end portion 48b. The spring seat 46d is a disk-shaped member with an outer diameter larger than that of the shaft 46. A set collar with a slit formed therein is used as the spring seat 46d. The spring seat 46d is removably attached to the shaft 46 by bolts (not illustrated). The position of the spring seat 46d can be adjusted by moving the spring seat 46d along the shaft 46 with the bolts loosened. A coil spring 49c is arranged between the spring seat 46d and the second cover 49b, with the shaft 46 inserted. The coil spring 49c has an inner diameter larger than the outer diameter of the shaft 46 and an outer diameter smaller than the outer diameter of the spring seat 46d.

By making the gap between the spring seat 46d and the second cover 49b narrower than the natural length of the coil spring 49c, a repulsive force of the coil spring 49c acts on the second cover 49b and the second end portion 48b. Thus, the second cover 49b is pressed against the second end portion 48b of the roller body 48 by the coil spring 49c.

In the processing space inside an outer wall of a heat treatment furnace, the guide rollers that guide the workpiece rotate as the workpiece is conveyed. The roller body of the guide roller rotates against the shaft via the first bearing and the second bearing. According to the inventor's findings, friction can occur between components of the guide rollers at this time. There is concern that this may reduce the cleanliness (degree of cleanliness) in the processing space. For example, dust can be generated from the first bearing and the second bearing due to the friction generated among the inner ring, the outer ring, the rolling elements, and the retainer of each of the first bearing and the second bearing. The faster the conveyance speed, the greater the friction becomes, which may generate more dust from the first bearing and the second bearing. The cleanliness of the processing space can also be reduced, for example, in a case where grease filled in the first bearing and the second bearing is scattered.

In the embodiment described above, the heat treatment apparatus 10 includes the conveyance devices 20 and 22, the outer wall 41, and the guide rollers 45. The conveyance devices 20 and 22 convey the workpiece A. The outer wall 41 has therein the processing space 40a where the workpiece A is processed while being conveyed. The guide rollers 45 are provided in the processing space 40a and guide the workpiece A. The guide roller 45 has the shaft 46, the first bearing 47a and the second bearing 47b, the cylindrical roller body 48, and the first cover 49a and the second cover 49b. The first bearing 47a and the second bearing 47b are attached with the spacing therebetween in the axial direction of the shaft 46. The roller body 48 is rotatably attached to the shaft 46 via the first bearing 47a and the second bearing 47b. The first bearing 47a and the second bearing 47b have the inner rings 47al and 47b1, the outer rings 47a2 and 47b2, the plural rolling elements 47a3 and 47b3, and the retainers 47a4 and 47b4, respectively. The first cover 49a closes the gap between the inner ring 47al and the outer ring 47a2, on the outer side of the first bearing 47a along the axial direction of the shaft 46. The second cover 49b closes the gap between the inner ring 47b1 and the outer ring 47b2, on the outer side of the second bearing 47b along the axial direction of the shaft 46. With this configuration, dust that would otherwise be generated in the first bearing 47a and the second bearing 47b during the conveyance of the workpiece A is less likely to be produced within the processing space 40a. Even when grease is used in the first bearing 47a and the second bearing 47b, the grease is less likely to scatter into the processing space 40a. As a result, the cleanliness of the processing space 40a is improved.

Even when powder dust, scattered grease, and the like occur due to the friction between components such as the first bearing 47a and the second bearing 47b of the guide roller 45, the powder dust, scattered grease, or the like can be contained in the space 48d inside the roller body 48. The first cover 49a and the second cover 49b are provided on the outer sides of the first end portion 48a and the second end portion 48b of the roller body 48, respectively, thereby preventing powder dust, scattered grease, and the like from being discharged from the space 48d inside the roller body 48 into the processing space 40a.

In the embodiment described above, the second cover 49b is pressed against the second end portion 48b of the roller body 48 by the coil spring 49c. Thus, the second cover 49b can be stably pressed against the second end portion 48b even when the dimensions of the shaft 46, the roller body 48, and the like change due to temperature changes in the processing space 40a. As a result, dust and the like generated from the first bearing 47a and the second bearing 47b can be suppressed. Note that the arrangement of the covers is not limited to the embodiment described above, and the first cover 49a may be pressed against the first end portion 48a of the roller body 48 by the coil spring 49c. Both the first cover 49a and the second cover 49b may be pressed against the first end portion 48a and the second end portion 48b of the roller body 48 by the coil spring 49c, respectively.

In the embodiment described above, the shaft 46 is provided with the spring seat 46d outside the second end portion 48b. The coil spring 49c is arranged between the spring seat 46d and the second end portion 48b. The position of the coil spring 49c is adjusted by the spring seat 46d, so that the first cover 49a and the second cover 49b are stably pressed, thereby preventing powder dust and the like from scattering within the processing space 40a.

In the embodiment described above, the shaft 46 is provided with the stepped portion 46c on the outer side from the position where the first bearing 47a is attached. The first cover 49a is sandwiched between the stepped portion 46c and the first end portion 48a of the roller body 48. Thus, the first cover 49a is positioned on the shaft 46, making it easier to cover the first end portion 48a.

In the embodiment described above, the first bearing 47a and the second bearing 47b are ceramic bearings. This can reduce the generation of dust from the first bearing 47a and the second bearing 47b when the guide roller 45 rotates along with the conveyance of the workpiece A. Furthermore, by using ceramic materials with good self-lubricating properties for the first bearing 47a and the second bearing 47b, there is no need to fill grease between the components. Consequently, grease scattering is no longer a concern, and the cleanliness of the processing space 40a can be easily improved.

In the embodiment described above, the first cover 49a is positioned on the shaft 46. The second cover 49b is pressed against the second end portion 48b of the roller body 48 by the coil spring 49c. Thus, the position of the guide roller 45 is stabilized.

In the embodiment described above, the outer wall 41 is connected to the vacuum pump 80 that reduces the pressure in the processing space 40a. In the heat treatment apparatus 10 where the pressure in the processing space 40a is reduced by the vacuum pump 80, dust that may be generated from the guide rollers 45 during the treatment can significantly affect the cleanliness of the processing space 40a. Therefore, when adopting the above-mentioned configuration of the guide roller 45, the effect of improving the cleanliness can become greater.

In the heat treatment apparatus 10, the guide rollers 45 are supported by a pair of support plates 90a and 90b provided in the processing space 40a.

<Pair of Support Plates 90a and 90b>

The pair of support plates 90a and 90b is provided within the processing space 40a of the heat treatment unit 40. Although a detailed illustration thereof is omitted, the pair of support plates 90a and 90b is a pair of plate-shaped members that extends along the direction in which the guide rollers 45b are aligned (front-back direction). The pair of support plates 90a and 90b supports the plural guide rollers 45b arranged in the front-back direction. The pair of support plates 90a and 90b are arranged with a spacing longer than the width of the workpiece A so as to sandwich the conveyance route for the workpiece A therebetween. The pair of support plates 90a and 90b are provided with insertion holes 90al and 90b1 through which the shaft 46 is inserted, respectively. The insertion holes 90al and 90b1 are opened in a substantially circular shape. The shaft 46 is inserted into the insertion holes 90al and 90b1. In this embodiment, the guide roller 45 is supported by the pair of support plates 90a and 90b via the first support member 44a and the second support member 44b.

The first support member 44a is attached to the first end portion 46a of the shaft 46. The stepped portion 46c with a larger diameter than the first end portion 46a is provided on the inner side with respect to the first end portion 46a. The stepped portion 46c is provided on the outer side of the first cover 49a. The second support member 44b is attached to the second end portion 46b of the shaft 46. The first support member 44a and the second support member 44b have insertion holes 44al and 44b1 penetrating along the axis of the shaft 46, respectively. The shaft 46 is attached to the first support member 44a and the second support member 44b with the shaft 46 being inserted through the insertion holes 44al and 44b1. The inner diameters of the insertion holes 44al and 44b1 are set to be substantially the same as the outer diameters of the first end portion 46a and the second end portion 46b of the shaft 46, respectively.

<First Support Member 44a>

The first support member 44a has an insertion portion 44a2, a flange portion 44a3, and an end portion 44a4. The insertion portion 44a2, the flange portion 44a3, and the end portion 44a4 may be different members or may be integrally constructed. The outer shapes of the insertion portion 44a2, the flange portion 44a3 and the end portion 44a4 are substantially annular. The insertion portion 44a2 is a portion that is inserted into the insertion hole 90al of a support plate 90a. The flange portion 44a3 is a portion with a larger diameter than the insertion portion 44a2 and the end portion 44a4. The end portion 44a4 can be a set collar provided with a slit.

The first end portion 46a has a smaller diameter than the stepped portion 46c. The first support member 44a is attached to the shaft 46 in a state where the insertion portion 44a2 of the first support member 44a is abutted against and positioned by the stepped portion 46c. The insertion hole 44al of the first support member 44a has substantially the same length as the first end portion 46a of the shaft 46. Thus, the first end portion 46a of the shaft 46 and the end portion 44a4 of the first support member 44a are aligned with each other. The first support member 44a is attached to the first end portion 46a of the shaft 46 by tightening the end portion 44a4 against the first end portion 46a of the shaft 46.

The first support member 44a is attached to the support plate 90a in a state of being attached to the first end portion 46a of the shaft 46. In other words, the first end portion 46a of the shaft 46 is attached to the support plate 90a via the first support member 44a. Here, the first support member 44a is attached to the support plate 90a with the flange portion 44a3 contacting an outer surface of the support plate 90a and with the insertion portion 44a2 inserted into the insertion hole 90al of the support plate 90a. In addition, here, the flange portion 44a3 of the first support member 44a is attached to the support plate 90a by bolts (not illustrated). Thus, the positions of the guide rollers 45 in the processing space 40a can be stabilized.

<Second Support Member 44b>

The second support member 44b has an insertion portion 44b2, a flange portion 44b3, and an end portion 44b4. The insertion portion 44b2, the flange portion 44b3, and the end portion 44b4 may be different members or may be integrally constructed. The outer shapes of the insertion portion 44b2 and the end portion 44b4 are substantially annular. The outer shape of the flange portion 44b3 is substantially square with chamfered corners (see FIG. 4). The insertion portion 44b2 is a portion that is inserted into the insertion hole 90b1 of the support plate 90b. The flange portion 44b3 is a portion with a larger diameter than the insertion portion 44b2 and the end portion 44b4. The end portion 44b4 can be a set collar provided with a slit.

The second support member 44b is set to have such dimensions that the end portion 44b4 is substantially aligned with the second end portion 46b of the shaft 46 when attached to the support plate 90b. The second end portion 46b of the shaft 46 is inserted into the insertion hole 44b1 of the second support member 44b. The second end portion 46b of the shaft 46 is not fixed to the insertion hole 44b1 of the second support member 44b. During the heat-treatment of the workpiece A, the shaft 46 slides on an inner circumferential surface of the insertion hole 44b1 of the second support member 44b, even when the length of the shaft 46 changes due to temperature changes. This suppresses the application of load onto the shaft 46.

The second support member 44b is attached to the support plate 90b with the flange portion 44b3 contacting an outer surface of the support plate 90b and with the insertion portion 44b2 inserted into the insertion hole 90b1 of the support plate 90b.

As illustrated in FIG. 4, insertion holes 44b5 are provided at four corners of the flange portion 44b3 of the second support member 44b. The second support member 44b is attached to the support plate 90b (see FIG. 3) by bolts 44b6 inserted through the insertion holes 44b5. The inner diameter of the insertion hole 44b5 is set to a dimension slightly larger than the outer diameter of an area through which the bolt 44b6 is inserted. Thus, the flange portion 44b3 moves along the outer surface of the support plate 90b by a difference between the inner diameter of the insertion hole 44b5 and the outer diameter of the bolt 44b6, even when the bolt 44b6 is tightened. The second support member 44b is configured such that its position is adjustable along the outer surface of the support plate 90b by position adjustment members 44d.

Each of the position adjustment members 44d is provided in proximity to a corresponding one of a lower surface 44ba, a front side surface 44bb, and a rear side surface 44bc of the flange portion 44b3. The position adjustment member 44d has a base 44d1 attached to the support plate 90b and an adjustment screw 44d2 inserted into the base 44d1. The tips of the adjustment screws 44d2 penetrate the respective bases 44d1 and reach the corresponding surfaces 44ba to 44bc of the flange portion 44b3. By turning the adjustment screws 44d2, the positions of the tips can be adjusted, thereby adjusting the position of the flange portion 44b3 on the outer surface of the support plate 90b.

In this embodiment, the insertion hole 90b1 is larger than the outer shape of the roller body 48 (see FIG. 3). During maintenance or the like, the guide roller 45 is removed in the following way. The second support member 44b is removed from the support plate 90b. A cylindrical member that is larger than the outer shape of the roller body 48 and has a diameter smaller than the inner diameter of the insertion hole 90b1 is inserted into the insertion hole 90b1. The first end portion 46a of the shaft 46 is removed from the first support member 44a. The shaft 46 to which the roller body 48 is attached is removed from the second end portion 46b side. The cylindrical member inserted into the insertion hole 90b1 of the support plate 90b prevents the shaft 46 and the roller body 48 from falling off, ensuring good workability during replacement.

The configurations of the guide rollers and the like included in the heat treatment apparatus disclosed herein have been described above using the case where the heat treatment unit is provided, as an example. However, the above guide rollers can exhibit the above-mentioned effects even when provided in locations other than the heat treatment unit. For example, the above guide roller may be provided in the cooling unit, the unwinding unit, the winding unit, and the like.

The above is a detailed description of the technology disclosed herein through the specific embodiments, but those are illustrative only and do not limit the scope of the claims. Accordingly, the technology described in claims includes various variations and modifications of the embodiments described above.

The present specification also includes the following Items 1 to 16. The following Items 1 to 16 are not limited to the above embodiments.

### Item 1:

A heat treatment apparatus including:
a conveyance device that conveys a strip-shaped workpiece;
an outer wall having therein a processing space where the workpiece is processed while being conveyed; and
a guide roller provided in the processing space and configured to guide the workpiece,
the guide roller including:
a shaft;
a first bearing and a second bearing that are attached with a spacing therebetween in an axial direction of the shaft;
a roller body having a cylindrical shape and rotatably attached to the shaft via the first bearing and the second bearing; and
a first cover and a second cover,
each of the first bearing and the second bearing including:
an inner ring affixed to the shaft;
an outer ring opposed to the inner ring in a radial direction of the inner ring;
a plurality of rolling elements arranged between the inner ring and the outer ring; and
a retainer arranged between the inner ring and the outer ring and retaining the plurality of rolling elements, wherein
the first cover and the second cover close corresponding gaps between the inner ring and the outer ring, on outer sides of the first bearing and the second bearing, respectively, along the axial direction of the shaft.

### Item 2:

The heat treatment apparatus according to Item 1, wherein at least one of the first cover and the second cover is pressed against an end portion of the roller body by a coil spring.

### Item 3:

The heat treatment apparatus according to Item 2, wherein the shaft has a first end portion and a second end portion opposite to the first end portion,
the first cover is positioned on the shaft, and
the second cover is pressed against the roller body by the coil spring.

### Item 4

The heat treatment apparatus according to Item 3, wherein
the shaft is provided with a spring seat on an outer side of the second end portion, and
the coil spring is arranged between the spring seat and the second end portion.

### Item 5:

The heat treatment apparatus according to Item 3 or 4, wherein
the shaft is provided with a stepped portion on an outer side from a position where the first bearing is attached, and
the first cover is sandwiched between the stepped portion and a first end portion of the roller body.

### Item 6:

The heat treatment apparatus according to any one of Items 3 to 5, wherein
a pair of support plates is provided in the processing space, and
at least one of the first end portion and the second end portion of the shaft is attached to one of the pair of the support plates.

### Item 7:

The heat treatment apparatus according to any one of Items 1 to 6, wherein the outer wall is connected to a vacuum pump that reduces pressure in the processing space.

### Item 8:

The heat treatment apparatus according to any one of Items 1 to 7, wherein at least one of the first bearing and the second bearing is a ceramic bearing.

### Item 9:

The heat treatment apparatus according to any one of Items 1 to 8, wherein a space is formed between the roller body and the shaft.

### Item 10:

A guide roller for a heat treatment apparatus, the guide roller including:
a shaft;
a first bearing and a second bearing that are attached with a spacing therebetween in an axial direction of the shaft;
a roller body having a cylindrical shape and rotatably attached to the shaft via the first bearing and the second bearing; and
a first cover and a second cover,
each of the first bearing and the second bearing including:
an inner ring affixed to the shaft;
an outer ring opposed to the inner ring in a radial direction of the inner ring;
a plurality of rolling elements arranged between the inner ring and the outer ring; and
a retainer arranged between the inner ring and the outer ring and retaining the plurality of rolling elements, wherein
the first cover and the second cover close corresponding gaps between the inner ring and the outer ring, on outer sides of the first bearing and the second bearing, respectively, along the axial direction of the shaft.

### Item 11:

The guide roller for a heat treatment apparatus according to Item 10, wherein at least one of the first cover and the second cover is pressed against an end portion of the roller body by a coil spring.

### Item 12:

The guide roller for a heat treatment apparatus according to Item 11, wherein
the shaft has a first end portion and a second end portion opposite to the first end portion,
the first cover is positioned on the shaft, and
the second cover is pressed against the roller body by the coil spring.

### Item 13:

The guide roller for a heat treatment apparatus according to Item 12, wherein
the shaft is provided with a spring seat on an outer side of the second end portion, and
the coil spring is arranged between the spring seat and the second end portion.

### Item 14:

The guide roller for a heat treatment apparatus according to Item 12 or 13, wherein
the shaft is provided with a stepped portion on an outer side from a position where the first bearing is attached, and
the first cover is sandwiched between the stepped portion and a first end portion of the roller body.

### Item 15:

The guide roller for a heat treatment apparatus according to any of Items 10 to 14, wherein at least one of the first bearing and the second bearing is a ceramic bearing.

### Item 16:

The guide roller for a heat treatment apparatus according to any of Items 10 to 15, wherein a space is formed between the roller body and the shaft.

What is claimed is:

1. A heat treatment apparatus, comprising:
a conveyance device that conveys a strip-shaped workpiece;
an outer wall having therein a processing space where the workpiece is processed while being conveyed; and
a guide roller provided in the processing space and configured to guide the workpiece,
the guide roller including:
a shaft;
a first bearing and a second bearing that are attached with a spacing therebetween in an axial direction of the shaft;
a roller body having a cylindrical shape and rotatably attached to the shaft via the first bearing and the second bearing; and
a first cover and a second cover,
each of the first bearing and the second bearing including:
an inner ring affixed to the shaft;
an outer ring opposed to the inner ring in a radial direction of the inner ring;
a plurality of rolling elements arranged between the inner ring and the outer ring; and
a retainer arranged between the inner ring and the outer ring and retaining the plurality of rolling elements, wherein
the first cover and the second cover close corresponding gaps between the inner ring and the outer ring, on outer sides of the first bearing and the second bearing, respectively, along the axial direction of the shaft.

2. The heat treatment apparatus according to claim 1, wherein at least one of the first cover and the second cover is pressed against an end portion of the roller body by a coil spring.

3. The heat treatment apparatus according to claim 2, wherein
the shaft has a first end portion and a second end portion opposite to the first end portion,
the first cover is positioned on the shaft, and
the second cover is pressed against the roller body by the coil spring.

4. The heat treatment apparatus according to claim 3, wherein
the shaft is provided with a spring seat on an outer side of the second end portion, and
the coil spring is arranged between the spring seat and the second end portion.

5. The heat treatment apparatus according to claim 3, wherein
the shaft is provided with a stepped portion on an outer side from a position where the first bearing is attached, and
the first cover is sandwiched between the stepped portion and a first end portion of the roller body.

6. The heat treatment apparatus according to claim 3, wherein
a pair of support plates is provided in the processing space, and
at least one of the first end portion and the second end portion of the shaft is attached to one of the pair of the support plates.

7. The heat treatment apparatus according to claim 1, wherein the outer wall is connected to a vacuum pump that reduces pressure in the processing space.

8. The heat treatment apparatus according to claim 1, wherein at least one of the first bearing and the second bearing is a ceramic bearing.

9. The heat treatment apparatus according to claim 1, wherein a space is formed between the roller body and the shaft.

10. A guide roller for a heat treatment apparatus, the guide roller comprising:
a shaft;
a first bearing and a second bearing that are attached with a spacing therebetween in an axial direction of the shaft;
a roller body having a cylindrical shape and rotatably attached to the shaft via the first bearing and the second bearing; and
a first cover and a second cover,
each of the first bearing and the second bearing including:
an inner ring affixed to the shaft;
an outer ring opposed to the inner ring in a radial direction of the inner ring;
a plurality of rolling elements arranged between the inner ring and the outer ring; and
a retainer arranged between the inner ring and the outer ring and retaining the plurality of rolling elements, wherein
the first cover and the second cover close corresponding gaps between the inner ring and the outer ring, on outer sides of the first bearing and the second bearing, respectively, along the axial direction of the shaft.

11. The guide roller for a heat treatment apparatus according to claim 10, wherein at least one of the first cover and the second cover is pressed against an end portion of the roller body by a coil spring.

12. The guide roller for a heat treatment apparatus according to claim 11, wherein
the shaft has a first end portion and a second end portion opposite to the first end portion,
the first cover is positioned on the shaft, and
the second cover is pressed against the roller body by the coil spring.

13. The guide roller for a heat treatment apparatus according to claim 12, wherein
the shaft is provided with a spring seat on an outer side of the second end portion, and
the coil spring is arranged between the spring seat and the second end portion.

14. The guide roller for a heat treatment apparatus according to claim 12, wherein
the shaft is provided with a stepped portion on an outer side from a position where the first bearing is attached, and
the first cover is sandwiched between the stepped portion and a first end portion of the roller body.

15. The guide roller for a heat treatment apparatus according to claim 10, wherein at least one of the first bearing and the second bearing is a ceramic bearing.

16. The guide roller for a heat treatment apparatus according to claim 10, wherein a space is formed between the roller body and the shaft.
